(19) United States
(12) Patent Application Publication
(10) Pub. No.: US 2004/0045729 A1
(43) Pub. Date: Mar. 11, 2004

(54) Control system for discontinuous power drive

(76) Inventors: Mark W. Lehnert, Rochester Hills, MI (US); Paul Podsobinski, Rochester, MI (US)

Correspondence Address: Thomas D. Heimholodt, Young & Basile, P.C., Suite 624, 3001 West Big Beaver Road, Troy, MI, 48084, US

(21) Appl. No.: 10/658,301

(22) Filed: Sep. 9, 2003

Related U.S. Application Data
(60) Provisional application No. 60/409,372, filed on Sep. 9, 2002.

(51) Int. Cl. B25D 1/00

(52) U.S. Cl. 173/1; 173/176

(57) ABSTRACT

The fastening tool process controller provides an apparatus and process for programming, controlling, and comparison validation of the semi-automated operation of a transducer equipped and/or non-instrumented, pneumatically driven impulse or impact tool to a repeatable final shutdown torque value. The controller is taught a supply line pressure to output torque ratio for the particular pneumatic tool being used by validation against a NIST traceable standard torque transducer, or through manual checking with a normal torque wrench. This process is referred to as an automatic or manual teach cycle. The ratio provides the controller with the final required line pressure needed to achieve the pre-program torque targeted value. During a learn cycle, the micro-processor of the controller monitors values, either pressure differentials or acoustic signals, corresponding to mass air flow consumed while tightening a sample bolt into the actual application to the previous set torque target value. The data then provides a master volume signature based on mass air flow either pressure differential or acoustic signal, then provides a master signature to which subsequent fastener cycles can be compared for error proofing. An anomaly detection process rejects any fasteners that do not duplicate various threshold values based on the master signature. The controller has the option of tracking rejects and performing fastener counting if desired.

### FIELD OF THE INVENTION

The present invention relates to a control system and/or error proofing system based on a characteristic associated with fluid flow through a pressurized fluid supply conduit connected to a tool without requiring any additional modifications or ports to the standard tool (i.e. a zero additional port control system).

### BACKGROUND OF THE INVENTION

Tightening threaded fasteners to achieve a predetermined torque level is a dynamic task. There are many factors that need to be addressed during a tightening cycle. Prevailing torque fasteners require longer and/or higher rundown torque as the fasteners are deforming thread material. The industry uses the term “hard joint” for fastening cycles that begin from seated (initial surface contact) to fully tight in less than 30 degrees of angular rotation. Average fastening “joints” require 60 to 180 degrees of rotation to complete the tightening cycle. Soft joints (720 degrees or higher) such as hose clamps can continue displacing soft material for several rotations before the fastener can be considered fully tightened. Joint relaxation over time has been historically overlooked as a cause of fastener tightening failure due to the inability to monitor or control the applied force or torque after the tool has shut-off or been removed. Specialty fastener designs are used to attempt to minimize relaxation. All of these joint conditions require different rundown parameters for accurate control.

Transducers have been incorporated into tools to control shutdown at target torque through attempts of closed loop control circuits. Instrumented tools have proven to be very capable of being accurate, however the instrumented tools do not address joint relaxation. Use of impulse and impact tools can minimize or eliminate joint relaxation issues but are difficult to accurately control the final output torque.

U.S. Pat. No. 5,937,730 discloses a device operating as a cycle counting device. The assembly qualifier is a counting apparatus that monitors the pressure of an air tool. The device uses changes in air pressure against pre-set time windows to indicate whether a fastening cycle has been judged to have been successful. While the patent purports to verify proper fastening torque, the patent does not disclose any monitoring of torque applied and does not employ a monitored parameter that would allow verification of torque level. The device increments a counter to “qualify” the overall event against a pre-programmed number of expected and/or acceptable cycles. The device will signal error conditions by using a pressure sensor to monitor the pressure changes during the run cycle and by comparing the pressure changes against a “good” event signature as pre-programmed in order to interrupt the cycle in response to the occurrence of a defined unacceptable event. Even though the device is described as a “qualifier,” it does not actually control the tool. It simply monitors air pressure changes as mapped against the time line of the fastening cycle. The device then compares each fastening cycle to a series of “windows” that are placed over a known “good” fastening event plot of pressure against time.

U.S. Pat. No. 5,592,396 uses air flow to map the fastening event. However, the patent does not use the flow signature for control, but rather as a “trigger” signal to start counting either the onset of a snug point or the proper starting point (based on attaining a sufficient amplitude) of pulses from an impact type power tool. The patent indicates that in an impact wrench, the pulse nature of the flow signal during the tightening (hammering) allows the blows (impacts) to be easily counted for monitoring or control purposes. The process for setting up the system is complicated and requires significant operator input and decision making, or in the alternative, requires a considerable amount of data collection for the computer to properly develop the limits through calculations. The patent indicates that a series of “normal” tightenings, preferably at least 25, can be preformed and the results recorded manually or transferred automatically to a computer. By statistically evaluating these results in the computer, useful limits can then be set in the computer. These limits can then be used for trapping (identifying) trends or deviations from learned normal conditions. The patent indicates that for a pulse impact type tool, the device starts to count the number of pulses once the amplitude level exceeds a predetermined level. The device controls the number of pulses counted, and then calculates the area under each pulse to determine the total energy of the controlled number of pulses by a mathematically derived equivalent torque value. Attempts at qualifying the event are accomplished by mathematically comparing the summation of the total area represented by the pulses to pre-programmed high and low torque limits to determine acceptance based on the torque limits.

### SUMMARY OF THE INVENTION

It would be desirable in the present invention to provide a system for controlling and/or error proofing a pulse impact tool by monitoring a characteristic associated with fluid flow to the tool at a distance remote from the tool. It would be desirable in the present invention to provide a system capable of a simple, fast, set up for various types of fasteners to be tightened. It would be desirable in the present invention to provide a system for controlling a pulse impact tool by monitoring a characteristic associated with fluid flow, where the characteristic is at least one of differential pressure through an orifice and/or acoustic signal monitoring of the fluid drive rotation, where either of the monitoring sensor can be positioned remotely with respect to the pulse impact tool being driven.

The present invention provides a control device that can be easily fitted to existing and future impulse and impact type tool applications. The controller according to the present invention can be programmed with variables, such as rundown speed control, low torque dwell speed, high torque ramp up rate, high torque dwell speed, and shutdown torque. The controller according to the present invention can be programmed with multiple parameter configurations so that different joint types and/or sizes of fasteners can be properly tightened with the same tool. The parameter corresponding to high volume flow rate bench mark based on an acceptable fluid flow signature provides tool cycle speed and torque control, and can also reject a fastener cycle. A fluid flow rate anomaly detection process can reject attempts to tighten the same fastener more than one time. The fluid flow rate anomaly detection process can also reject cycles that indicate excessive flow, as is the case if the fastener has slipped out of the driving socket.

The pressurized fluid supply line to the tool can provide means for acoustically coupling motor speed data to the controller. For example, the motor contained in most pneumatically driven fastener tightening tools is a single- or double-chambered rotary vane type motor. The flow of compressed air through the expansion chambers within the motor is switched by the action of the rotating vanes as the vanes cover and uncover the internal air chamber supply port. This pulsing of air results in an audio tone with a frequency that is directly proportional to the speed of the motor and the number of vanes and chambers. An acoustic sensor can be used to collect this data. Although the sensor can be located at any position in, on, or near the tool inlet or exhaust ports, the preferred location according to the present invention is inside the compressed air supply metering system contained within the controller. The output of the acoustic sensor is fed into a signal conditioning frequency to voltage conversion circuit that gives an output voltage level proportional to motor speed. The speed signal is plotted against time to generate a signature of the fastener cycle. The signature also provides means for closed loop speed control. It is desirable to provide closed loop speed control for hard joint conditions. The use of low-cost tools connected to the controller provides joint quality control approaching that of fully instrumented tools. Multiple spindle tools can also be easily controlled to provide a gradual or sequential pre-torque value and then advance simultaneously to a final target torque.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic diagram illustrating a typical controller installation according to the present invention;

FIG. 2 is a graph illustrating pressure versus time during a first step of a setup according to the present invention, where the controller learns the tool properties of a tool connected to the controller;

FIG. 3 is a dual graph illustrating pressure versus time in the upper portion and flow versus time in the lower portion during another step of the learning process according to the present invention, where the controller determines the time required to reach a target torque value during tightening of a fastener at the predetermined pressure set as a result of the first step illustrated in FIG. 2, where the lower portion of the graph illustrates the flow versus time of an acceptable fastener tightening cycle;

FIG. 4 is a dual graph illustrating pressure versus time in the upper portion and flow versus time in the lower portion during a another step of the learning process, where the controller is taught the flow characteristics of a rehit on a previously tightened fastener at the pressure set as a result of the learning process of FIG. 2;

FIG. 5 is a dual graph illustrating pressure versus time in the upper portion and flow versus time in the lower portion during another step of the learning process, where the controller is taught a prevailing torque free flow value at the pressure set as a result of the learning process of FIG. 2; and

FIG. 6 is a graph illustrating flow versus time according to the learned parameter properties taught to the controller as illustrated in the steps of FIGS. 2 through 5 with various learned or recognized anomalies illustrated.

### DESCRIPTION OF THE PREFERRED EMBODIMENT

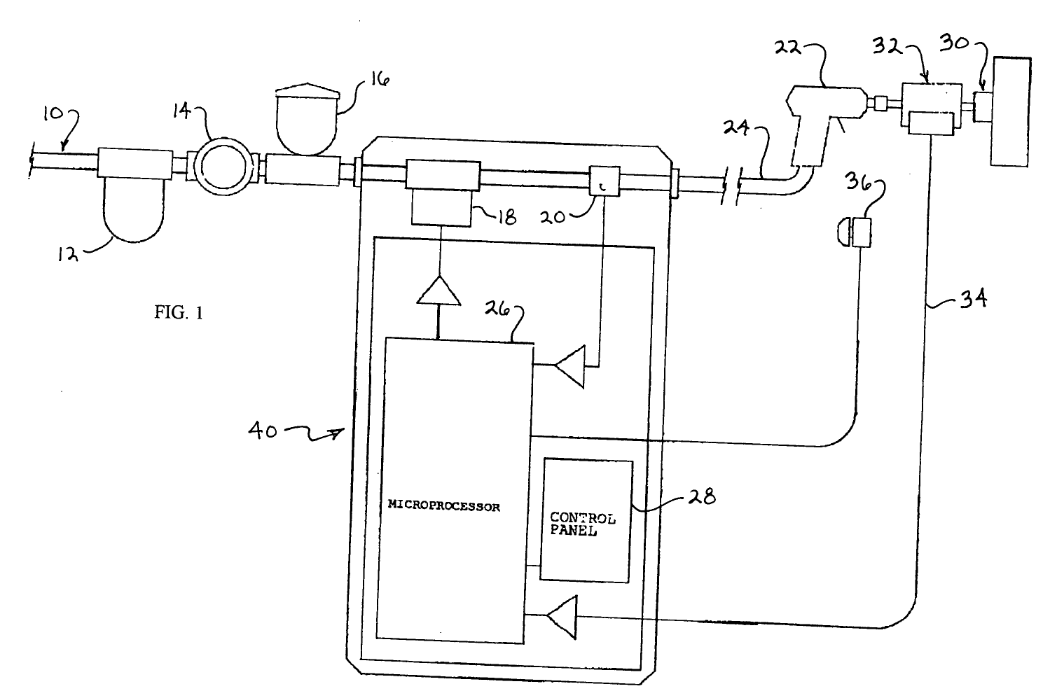

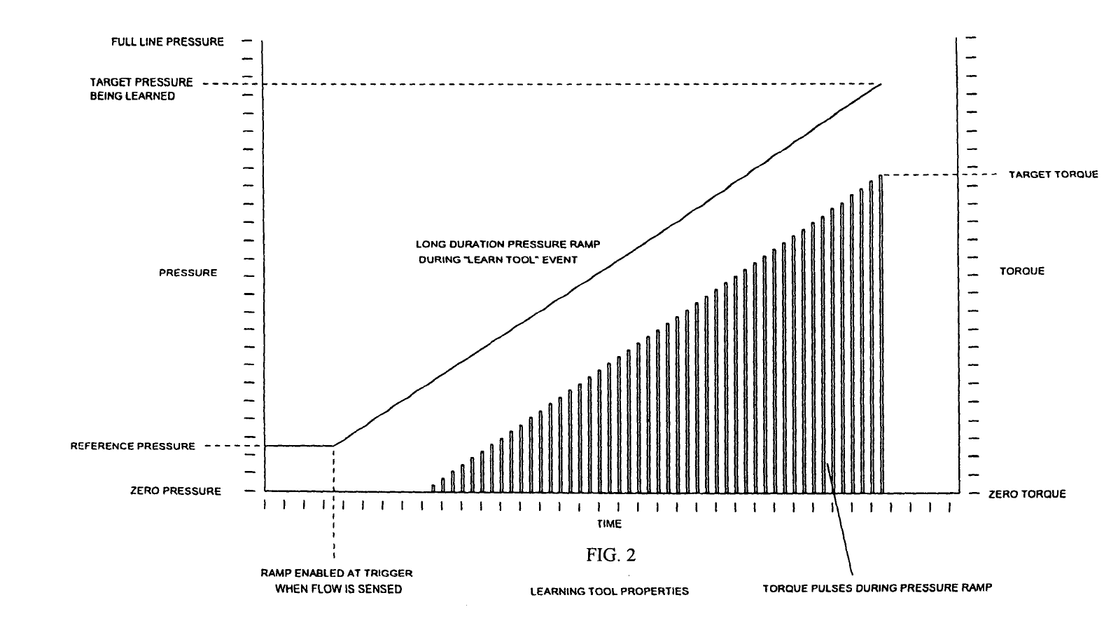

Referring now to FIG. 1, a typical installation according to the present invention includes a compressed fluid source 10, such as compressed air. The compressed air supply delivered by the compressed air source 10 is preferably cleaned by an optional moisture trap/filter 12. The clean air can also preferably pass through an optional pre-controller pressure regulator 14. Clean, regulated, compressed air then flows through an optional automatic lubricating oil injection system 16. Clean, regulated, lubricated, compressed air then flows through the internal control regulator 18 and sensor 20, such as an acoustic sensor and/or flow sensor, according to the present invention. Controlled fluid flow is connected to the fluid powered tool 22 through a standard supply hose 24. The signal from the sensor 20 can be received by a central processing unit 26, such as a microprocessor, for controlling the operation of the internal control regulator 18 in response to a program stored in memory. A control panel 28 can be operably connected to the central processing unit 26 for providing operator input to the control program, and for providing display of output from the central processing unit 26 in accordance with the program stored in memory. A test joint or the actual fastener joint 30 is illustrated in FIG. 1. In the illustrated configuration, a transducer 32 is connectible between the pneumatic tool 22 and the fastener joint 30 in order to perform one or more of the learning steps illustrated in FIGS. 2-5. The transducer 32 can be connected through cable 34 to the central processing unit 26. The transducer 32 is required to perform automatic closed loop learned functions and audit functions as described in greater detail below. A switch 36 can be provided for running a reverse remote cycle which electronically bypasses all internal metering devices for a single reverse cycle, or latches to remove fasteners in a batch. The controller 40 can be positioned in the compressed air supply line remote from the pneumatic tool 22 to be controlled, where the only connection between the controller 40 and the pneumatic tool 22 during normal operation (excluding the learn cycle) is the standard supply hose 24. The controller 40 can include a printed circuit board and power supply. The internal air pressure control regulator 18 can include a linear, voltage controlled, pressure regulator for metering the air pressure. The sensor 20 can include a differential pressure sensor for sensing mass air flow between ports on either side of a precision orifice, or can include an acoustic sensor.

By way of example and not limitation, the control panel can include a display, such as a two-line by 8-character display, and mode select switches, such as “transducer calibration,” “learn tool,” “learn application,” and “run” buttons. Multiple programmable run buttons can be provided for programming different fastener joint cycles to be performed. Additional buttons can be provided if required for programing purposes. A switch 36 can be located either as part of the control panel 28, or can be located remotely if the controller is not in close proximity to the tool operator. The set up procedure requires the use of a torque transducer 32. The shunt calibration and full-scale output controls can be available through the control panel while programming parameters into the controller 40. The control panel 28 can also optionally include a fastener counting display to indicate the progress, as well as total number of fasteners, for a station cycle. Optionally, an input and relay output terminal strip can be provided for remote control of all features of the controller.

Referring now to FIG. 2, every tool needs to be run against a calibrated source while being programmed. This can be accomplished by using a stationary transducer and a test joint, or a rotary transducer and the actual joint connection application. In either case, the controller 40 must receive the full-scale torque value of the transducer as input either manually or automatically. The gain and zero settings of the controller 40 can be adjusted to reflect the transducer output values. This calibration process can begin with the selection by the operator of the nomenclature used to define torque. Depressing a “setup” button causes the controller 40 to display the “units” on the character display, where torque will be displayed. The operator can make a selection while cycling through the available options, such as foot-pounds, Newton-meters, inch-pounds, etc. using a selector up arrow/down arrow control. Depressing the “setup” button again allows the operator to insert the full-scale value of the transducer to be used. Depressing the “setup” button a third time can prompt the operator to perform a shunt calibration and adjust the gain and zero settings for the controller 40. After the calibration is completed, the controller is taught the parameter of a fastening cycle. The controller 40 can be programmed with a plurality of different parameter instruction sets for different fastener joint applications to be processed by the connected tool. To teach a new parameter set to the controller 40, the operator depresses the “learn” button. The controller 40 responds with a request for a file name of the particular instruction set. The operator can cycle through a menu of available names in order to make a selection. Depressing the “learn” button again prompts the operator to modify the low torque dwell time duration if needed. This displays a controller generated default value that in rare circumstances can require modification, such as in the presence of prevailing torque. Depressing the “learn” button again allows the operator to enter a final torque value for the tightening cycle using the “up/down” arrow controls. Depressing the “learn” button again prompts the operator to modify a controller generated default final torque dwell time. During the default final torque dwell time, the fastener being tightened will be pulsed at the final torque value to ensure that joint relaxation issues are corrected. Depressing the “learn” button will prompt the operator to enter the number of fastener cycles required for the particular joint connection application. The operator can use the “up/down” arrow controls to program the desired value. The capability of a tool connected to the controller is mapped against supply pressure to determine the appropriate shut-down point. The operator of the tool depresses the “learn tool and joint” button. This initiates a controller “learn” cycle. The controller prompts the operator by displaying “run test joint” on the controller display. The operator now runs the tool one complete “learn” cycle. This single one test fastener can be run either in the particular joint application while monitoring applied torque with an inline slip ring transducer 32, or using a bench top instrument test joint. By depressing and holding the trigger of the tool 22, the operator signals the controller that it is time to run the test. The controller has read and stored all of the parameter information input by the operator. The full-scale transducer torque has been determined as valid as it is near but not less than the selected target torque. The controller calculates a default value for rundown torque as a percentage of the final rundown value. The controller 40 calculates a long duration pressure ramp illustrated in FIG. 2. The controller 40 starts the ramp. At some point, the tool under test will accelerate, run down the fastener, and begin pulsing or impacting. The air ramp continues until the magnitude of the transducer torque pulses are equal with the operator assigned torque value. The controller 40 now knows a default rundown pressure as well as the torque target air pressure. The controller can request information regarding reject tracking by displaying “reject” on the top line of the display. The operator can select either “track” or “ignore” by depressing the “up/down” arrow selector switches as required. The controller calculates the entire fastener tightening control ramp. The regulator can be directed to control the pressure output at a value corresponding to the level required in order to achieve the target torque value. The remaining learn cycles and joint fastening cycles occur at the selected, controlled compressed air pressure value learned during the cycle illustrated in FIG. 2.

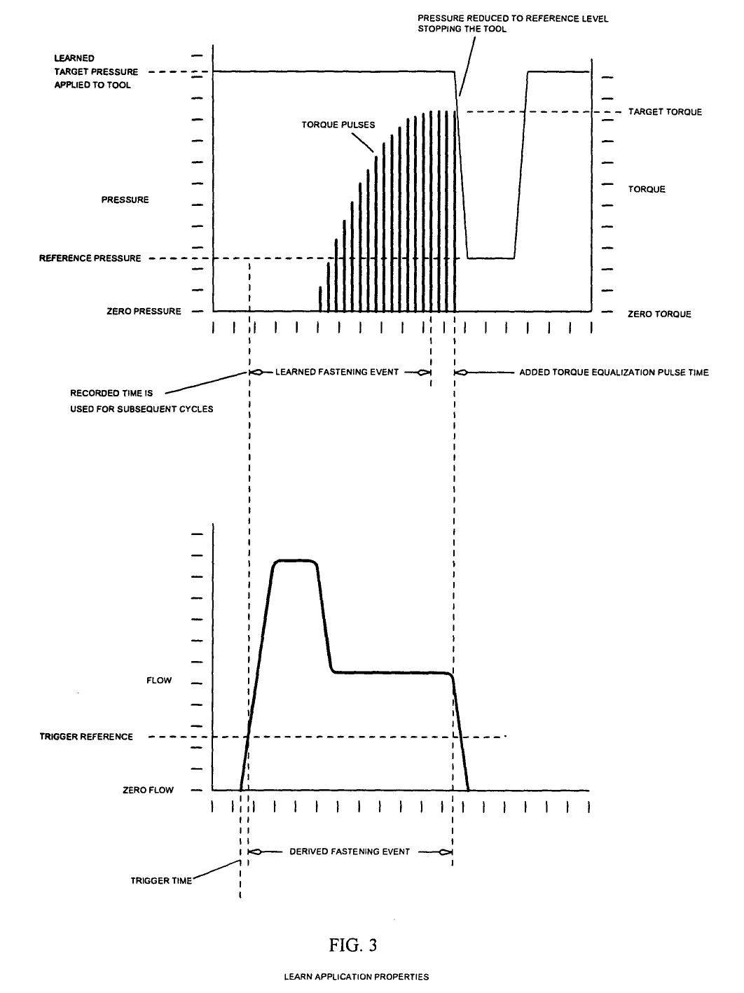

Referring now to FIG. 3, the learned target pressure is applied to the tool while the controller 40 learns the flow characteristics of a fastening event. The initial air flow curve initially jumps to a relatively high value as the hose is charged and the tool runs the fastener down toward a snug position. As the fastener reaches the snug position, the air flow curve drops to a lower value as work is performed tightening the fastener. The air flow drops off to zero when the target torque value has been reached plus an added torque equalization pulse time period as illustrated. This learn cycle is performed at the predefined controlled compressed air pressure value as set in the learning step illustrated in FIG. 2.

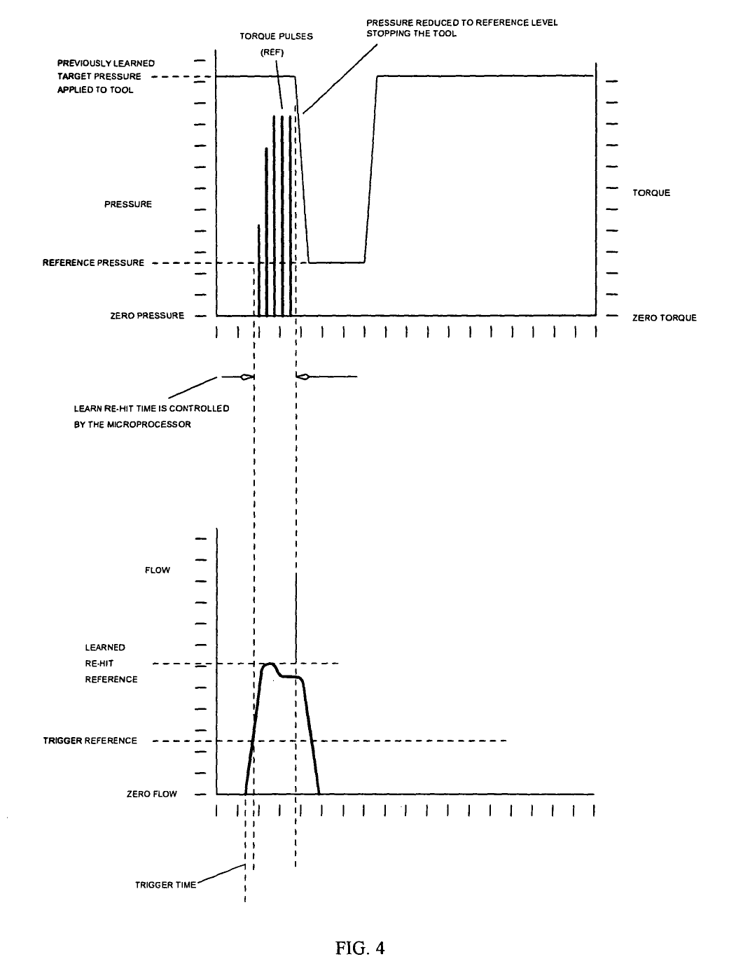

Referring now to FIG. 4, the learn cycle continues to teach the controller 40 to differentiate between a fastening event for the particular application versus re-hitting a previously tightened fastener. In FIG. 4, the graphs illustrate pressure versus time in the upper portion and flow versus time in the lower portion where the operator is instructed by the controller 40 to re-hit a previously tightened fastener. The controller 40 is taught that the re-hit cycle does not reach the upper flow level previously seen for the fastening event. The re-hit learn cycle is operated at the predetermined controlled pressure level required for the desired torque value as taught in the step illustrated in FIG. 2. This learn cycle is performed at the predefined controlled compressed air pressure value as set in the learning step illustrated in FIG. 2.

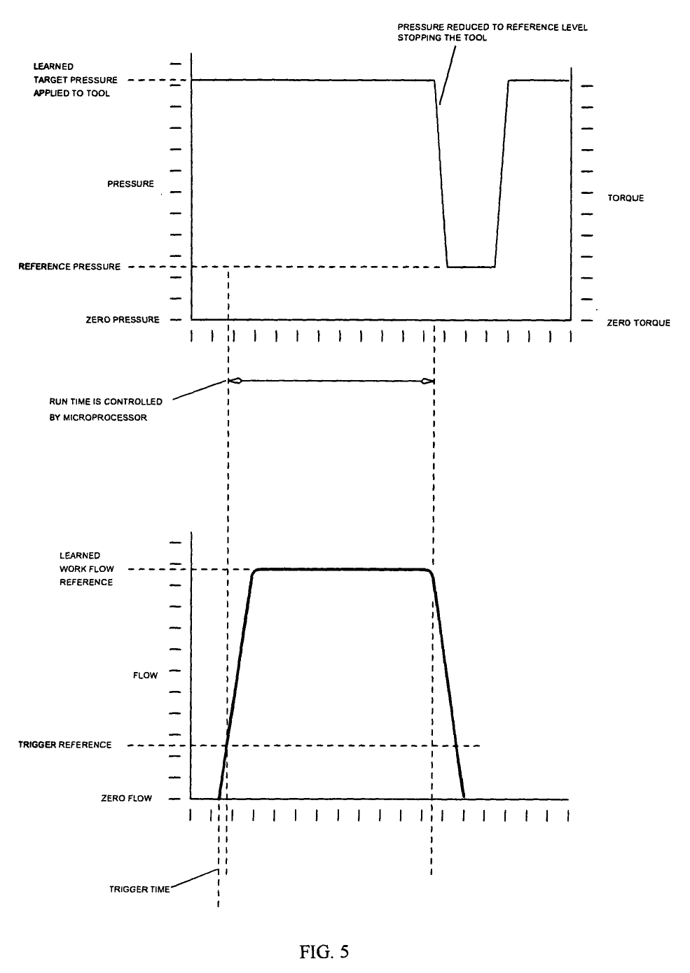

Referring now to FIG. 5, the operator is instructed to teach the controller 40 the prevailing torque free flow value by operating the tool 22 while not engaging the fastener. These are sometimes referred to as “air bolts”. This process can be seen in FIG. 5, where pressure versus time is shown in the upper portion and flow versus time is shown in the lower portion. A rapid ramp up of the flow to the free flow value through the pneumatic tool 22 is illustrated until the trigger is released. This learn cycle is performed at the predefined controlled compressed air pressure value as set in the learning step illustrated in FIG. 2.

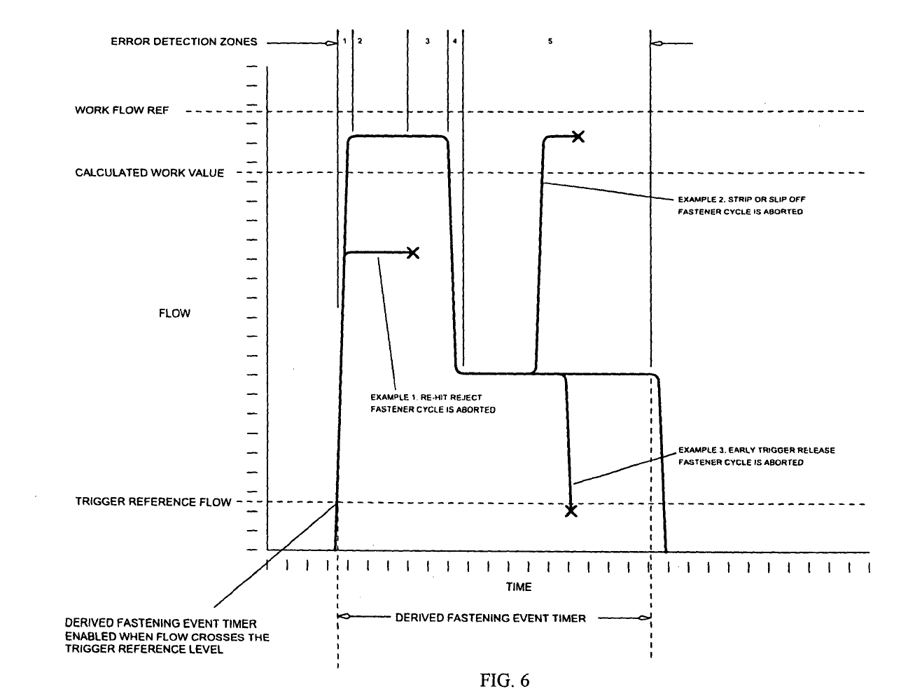

As a result of the learning steps illustrated in FIGS. 2 through 5, the controller 40 has learned the parameter properties for a particular fastener application as illustrated in FIG. 6. The transducer 32 is only required for the initial setup while depressing the “learn” parameter set button described with respect to the learn cycle illustrated in FIGS. 2 through 5. The transducer 32 is not required for normal operation once the learned parameter properties have been set by completion of the learn cycle illustrated in FIGS. 2 through 5.

FIG. 6 illustrates the learned parameter properties for a particular fastener connection application depicting flow versus time. It should be noted that the same curves would exist if the sensor were measuring an acoustic signal rather than flow. In either case, the control system according to the present invention includes a trigger reference flow rate, where the derived fastener event timer is enabled when the flow rate crosses the trigger reference level. The trigger reference level flow rate value is set sufficiently high to ignore any potential losses through the compressed air delivery supply hose 24 to the pneumatic tool 22. In error detection zones 2 through 3, the controller 40 according to the present invention can determine whether the operator has re-hit a previously tightened fastener, which is rejected and the cycle is aborted. In error detection zones 4 through 5, the controller 40 according to the present invention can determine whether the fastener has been stripped, or the socket has slipped of from the fastener during the fastening cycle, causing the cycle to be aborted and the fastener joint to be rejected. Additionally, during the error detection zones 4 and 5, the controller 40 according to the present invention can determine whether the operator released the trigger early prior to the fastener cycle being completed, so that the cycle is aborted and the fastener joint is rejected. If the flow or acoustic signal rises above the trigger reference flow and above the calculated work value and then declines below the calculated work value in zone 4 but remains above the trigger reference flow in zone 5, a fastener cycle has been successfully completed and is accepted.

The present invention provides a control system to control direct-drive pneumatic screwdrivers, and nut runners, including stall, air shut-off, and clutch shut-off type tools. When used with a clutch type or shut-off tool, the present invention requires the mechanism to be set at a level safely above the highest desired torque. In a defined system at any given air pressure, air flow is inversely proportional to load (torque). As the torque output of a tool increases, the speed and air flow of the tool both decrease until reaching the stall point. At stall, the normal running clearances within the air motor will leak (flow) a predetermined amount of air. In an auto teach mode, the present invention can be provided with a rotary torque transducer in-line and connected to the controller. By way of example and not limitation, the controller can run the tool on a soft joint having greater than 720° of rotation at full pressure to stall. The controller records the peak torque achieved/pressure and the stall condition air-flow rate. Given that torque output is proportional to air pressure, the microprocessor can calculate and set the pressure level required to obtain any specific torque within the range of the tool (typically 50% to 90% of capacity). In a manual teach mode according to the present invention, calibration of the system is possible with an accurate torque wrench by carefully measuring residual torque. After selecting manual teach, by way of example and not limitation, the controller can run the tool on a soft joint application of greater than 720° of rotation from seating to final stall. Care should be taken to prevent any unexpected torque reaction by properly bracing the tool. The controller will run the tool at full pressure (by way of example and not limitation 87 psi or 6 Bar, to stall). The operator will manually measure the torque using the torque wrench and manually input the reading to the controller. The controller will record the peak torque achieved/pressure and the stall condition air-flow rate (cfm). Given that torque output is proportional pressure, the microprocessor can now calculate and set the pressure level required to obtain any specific torque within the range of the tool (typically 50% to 90% of capacity). When operating in the learn mode according to the present invention, the controller can run the tool on the actual fastener joint application. From one of the previous teach modes, the controller calibrated and set the appropriate pressure level, calculated and adjusted to a predefined over-pressure to insure that the tool will be capable of reaching the desired torque. The tool will run at this fixed pressure (maintained at a constant level by the internal air pressure regulator) until the flow rate slows to an internally programmed flow rate (approximately 10% above the stall air leakage rate). At this point in the fastening cycle, the controller immediately cuts the pressure to 0 psi and holds it off for a preset amount of time (approximately 750 milliseconds). This gives a reliable shut-off at the desired target torque level and insures that the operator can release the throttle and/or position the tool for the next fastening cycle. During the fastening cycle, the controller learns and records the air-flow signature to be used in qualifying and error proofing the event.

The fastener tool process controller according to the present invention is a microprocessor based device that controls applied torque and provides error proofing reports for a discontinuous drive air tool such as a hydraulic pulse tool or a mechanical impact wrench. The torque output of pneumatic tools is related to air pressure. Other devices have used pressure/time (sometimes pressure drop or pressure level change as a “trigger” event) and time intervals to attempt control of an impact wrench. Impulse tools use an internal fluid flow/pressure release and shut-off mechanism to control the torque output relatively independent of air pressure level or fluctuation. Another common practice in an attempt to control discontinuous drive tools is to monitor the amplitude (force) of each “impact blow” of the tool until a certain amplitude level is exceeded, then count the number of subsequent blows as a control parameter. Either mechanical “trip switch/shut-off valve” mechanism or a remote shut-off valve can be employed to shut the tool off once the control parameter has been achieved. Attempts at calculating the applied torque based on the “area under the curve” (of each impact blow and the cumulative total energy of the counted blows) in order to assign a calculated torque value has been tried as well as attempting to qualify the event by comparing this mathematically derived (calculated) torque value against programmed limit sets have proven to be inaccurate, untraceable (to NIST standards) and therefore unacceptable. The present invention neither employs this logic nor attempts any of these approaches to control or qualify the fastening event. The present invention uses the principle of equilibrium at a defined torque level for discontinuous drive tool control. One feature of the present invention is the dynamic learning capability of the controller when setting up the control parameters of an application, the dynamic pressure control (regardless of air flow level) and the ability to react to defined conditions to stop the air supply to the tool and quickly exhaust the air line to provide both torque control, error proofing detection and control. The primary factors being employed in the present invention for torque control and error proofing are air flow level monitoring, dynamic pressure control, dynamically “learned” timing control and application “signature”. This signature is made of dynamically “learned” intersection points at which the air flow value crosses to dynamically determined flow levels. These levels are termed working level (set by the microprocessor at a fixed percentage of “free-speed”) and stall (also fixed by the microprocessor as a percentage of flow at “impacting” flow).

The system according to the present invention can use flow monitoring, while allowing an internal control device (when present) of the tool to shut down the delivery of torque from the tool to the fastener. However, should the system according to the present invention detect any error conditions that indicate a rejected fastening cycle, the system will override the tool and shut down the air supply to the tool thereby controlling the tool and not allowing a bad fastening cycle. Additionally, by controlling the air pressure (not by simply monitoring the pressure), the system according to the present invention provides various supply torque levels without adjusting the internal device of the tool. The control system according to the present invention as based on flow rate crossing over “threshold” level and a monitoring timing window. After starting the tool, the flow rate will rise and cross over a predetermined level called “threshold”. While the tool is in a free speed condition or running in a fastener, the flow rate is above the threshold level. Until the flow level drops below this same threshold level, the time element is ignored. This ensures that “air bolts”, where the tool is not engaging a fastener, are not counted. After crossing the threshold level in the downward direction, the crossover point starts a timing monitor that is compared with previously determined minimum and maximum time parameters. When a fastener is correctly tightened, the torque level is controlled and the energy delivered to the fastener is stopped by the internal shut-off mechanism of the tool. When this occurs, the flow rate will decrease to a certain level called “stall rate”. If the tool correctly shuts off, the flow rate will be at the “stall rate”, a level above “zero” due to the leakage of air past the reset valve, internal rotor blades and end plates until the operator releases the trigger mechanism of the tool. At this time, flow rate will drop to “zero” when the operator releases the trigger mechanism of the tool. If the flow rate “knees over” within the timing window, the event is indicated as being an acceptable fastener cycle as the tool was correctly shut-off. However, if the knee-over occurs either outside of the window or the knee-over occurs at “zero” flow rate within the window, the event is determined to be a rejected fastener cycle. The conditions can be described as: (1) knee-over prior to minimum time line indicates a re-hit or defective fastener cycle; (2) knee-over after maximum time parameter indicates that the operator let go of the trigger early, allowed the tool to disengage, or “cam off”, from the fastener, or stripped the bolt, which in any case results in a defective fastener cycle; (3) knee-over within the timing window, but at “zero” flow rate indicates an early cycle abort or that the operator let go of the trigger prior to the end of the fastener cycle, in either case resulting in a defective fastener cycle; and (4) knee-over within the timing window above a minimum “stall rate” indicates an acceptable fastener cycle. In the event of a defective fastener cycle, the system according to the present invention shuts down the supply air flow to the tool either for a preset time period or until the reset command is received. When the control system according to the present invention is used, accurate and variable torque levels are able to be programmed via closed loop control of the air pressure level being preset during the setup phase while preserving the ability of the internal shut-off mechanism of the tool to operate.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for controlling an impact/pulse tool during a fastener tightening cycle comprising:
an inlet port for receiving a supply of pressurized fluid;
a fluid pressure regulator for maintaining a selectable pressure value to be delivered to the tool to be controlled in response to a control signal;
a sensor for measuring a characteristic corresponding to flow of the fluid to the tool to be controlled and for generating an output signal; and
a central processing unit for receiving the output signal from the sensor and for generating the control signal to be sent to the pressure regulator in response to the output signal from the sensor in accordance with a program stored in memory to control flow of fluid to the tool to be controlled.

2. The apparatus of claim 1, wherein the program further comprises a setup process for each fastener tightening cycle to be learned.

3. The apparatus of claim 2, wherein the setup process further comprises:
a transducer connectible between the tool to be controlled and the fastener to be tightened for generating a torque signal during a ramped pressure fastener tightening cycle; and
the central processing unit for receiving the torque signal from the transducer during the ramped pressure fastener tightening cycle, and for setting a fixed pressure value based on the received torque signal.

4. The apparatus of claim 2, wherein the setup process further comprises:
the central processing unit for receiving a torque value input by an operator using a manual torque wrench during a preset pressure fastener tightening cycle, and for setting a fixed pressure value based on the torque value input.

5. The apparatus of claim 2, wherein the setup process further comprises:
a transducer connectible between the tool to be controlled and the fastener to be tightened for generating a torque signal during the fastener tightening cycle at a fixed pressure value; and
the central processing unit for receiving the torque signal from the transducer during the fastener tightening cycle at a fixed pressure value, and for setting a fluid flow signature based on the output signal received from the sensor and the received torque signal.

6. The apparatus of claim 2, wherein the setup process further comprises:
the central processing unit for receiving the output signal from the sensor during a free air run process, and for setting a threshold value based on the received output signal.

7. The apparatus of claim 2, wherein the setup process further comprises:
the central processing unit for receiving the output signal from the sensor during a tightened fastener rehit cycle, and for setting a threshold value based on the received output signal.

8. The apparatus of claim 2, wherein the program further comprises a control program for each fastener tightening cycle to be performed.

9. The apparatus of claim 8, wherein the control program further comprises:
the central processing unit for receiving the output signal from the sensor during the fastener tightening cycle, and for comparing the output signal with bench marks stored in memory based on a previous fluid flow signature of an acceptable fastener tightening cycle for controlling fluid flow to the tool to be controlled.

10. The apparatus of claim 1, wherein the program further comprises an error proofing program for each fastener tightening cycle to be performed.

11. The apparatus of claim 10, wherein the error proofing program further comprises:
the central processing unit for receiving the output signal from the sensor during the fastener tightening cycle, and for comparing the output signal with bench marks stored in memory based on a previous fluid flow signature of an acceptable fastener tightening cycle for generating error proofing signals for the fastener tightening cycle based on the received output signal.

12. The apparatus of claim 1 further comprising:
an output port for supplying controlled fluid flow to the tool to be controlled through a standard fluid flow supply hose.

13. The apparatus of claim 1, wherein the characteristic corresponding to flow is at least one of differential pressure and acoustic data.

14. The apparatus of claim 1, wherein the pressurized fluid is compressed air.

15. The apparatus of claim 1 further comprising:
a switch operably connected to the central processing unit for running in a reverse cycle remote mode by electronically bypassing all internal metering for reverse cycle operation.

16. The apparatus of claim 1 further comprising:
a transducer connectible between the tool to be controlled and the fastener to be tightened and operably connectible to the central processing unit for running a setup process for a fastener tightening cycle to be learned.

17. A method for controlling an impact/pulse tool during a fastener tightening cycle comprising the steps of:
receiving a supply of pressurized fluid through an inlet port;
maintaining a selectable pressure value to be delivered to the tool to be controlled in response to a control signal with a fluid pressure regulator;
measuring a characteristic corresponding to flow of the fluid to the tool to be controlled with a sensor and generating an output signal; and
receiving the output signal from the sensor with a central processing unit and generating the control signal to be sent to the pressure regulator in response to the output signal from the sensor in accordance with a program stored in memory to control flow of fluid to the tool to be controlled.

18. The method of claim 17, wherein the program further comprises the step of running a setup process for each fastener tightening cycle to be learned.

19. The method of claim 18, wherein the setup process further comprises the steps of:
connecting a transducer between the tool to be controlled and the fastener to be tightened;
generating a torque signal during a ramped pressure fastener tightening cycle;
receiving the torque signal from the transducer with the central processing unit during the ramped pressure fastener tightening cycle; and
setting a fixed pressure value based on the received torque signal.

20. The method of claim 18, wherein the setup process further comprises the steps of:
receiving a torque value input by an operator using a manual torque wrench with the central processing unit during a preset pressure fastener tightening cycle; and
setting a fixed pressure value based on the torque value input.

21. The method of claim 18, wherein the setup process further comprises the steps of:
connecting a transducer between the tool to be controlled and the fastener to be tightened;
generating a torque signal during the fastener tightening cycle at a fixed pressure value; and
receiving the torque signal from the transducer with the central processing unit during the fastener tightening cycle at a fixed pressure value; and
setting a fluid flow signature based on the output signal received from the sensor and the received torque signal.

22. The method of claim 18, wherein the setup process further comprises the steps of:
receiving the output signal from the sensor during a free air run process with the central processing unit; and
setting a threshold value based on the received output signal.

23. The method of claim 18, wherein the setup process further comprises the steps of:
receiving the output signal from the sensor during a tightened fastener rehit cycle with the central processing unit; and
setting a threshold value based on the received output signal.

24. The method of claim 18, wherein the program further comprises the step of running a control program for each fastener tightening cycle to be performed.

25. The method of claim 24, wherein the control program further comprises the steps of:
receiving the output signal from the sensor during the fastener tightening cycle with the central processing unit;
comparing the output signal with bench marks stored in memory based on a previous fluid flow signature of an acceptable fastener tightening cycle; and
controlling fluid flow to the tool to be controlled based on results of the comparing step.

26. The method of claim 17, wherein the program further comprises the step of running an error proofing program for each fastener tightening cycle to be performed.

27. The method of claim 26, wherein the error proofing program further comprises the steps of:
receiving the output signal from the sensor during the fastener tightening cycle with the central processing unit;
comparing the output signal with bench marks stored in memory based on a previous fluid flow signature of an acceptable fastener tightening cycle; and
generating error proofing signals for the fastener tightening cycle based on the received output signal.

28. The method of claim 17 further comprising the step of:
supplying controlled fluid flow to the tool to be controlled through an output port and a standard fluid flow supply hose.

29. The method of claim 17, wherein the characteristic corresponding to flow is at least one of differential pressure and acoustic data.

30. The method of claim 17, wherein the pressurized fluid is compressed air.

31. The method of claim 17 further comprising the step of:
operably connecting a switch to the central processing unit for running in a reverse cycle remote mode by electronically bypassing all internal metering for reverse cycle operation.

32. The method of claim 17 further comprising the step of:
operably connecting a transducer between the tool to be controlled and the fastener to be tightened; and
operably connecting an torque signal from the transducer to the central processing unit for running a setup process for a fastener tightening cycle to be learned.
